(19) United States
(12) Patent Application Publication
(10) Pub. No.: US 2016/0214341 A1
(43) Pub. Date: Jul. 28, 2016

(54) AN APPARATUS AND A METHOD FOR COMPRESSING CONTAINERS

(71) Applicant: KRONES AG, Neutraubling (DE)

(72) Inventor: Jochen Krueger, Hagelstadt (DE)

(73) Assignee: Krones AG, Neutraubling (DE)

(21) Appl. No.: 14/916,675

(22) PCT Filed: Sep. 9, 2014
(86) PCT No.: PCT/EP2014/069148

§ 371 Date: Mar. 4, 2016

(30) Foreign Application Priority Data
Sep. 9, 2013 (DE) 10 2013 109 840.1

(51) Int. Cl. B30B 9/32; B30B 15/30; B29C 31/00; B65B 63/02

(52) U.S. Cl. CPC B30B 9/321; B65B 63/02; B30B 15/30; B29C 31/008; B29L 2031/712

(57) ABSTRACT

An apparatus (1) for compressing containers (10) and in particular plastics material containers with a first holding device (2) that is suitable for holding a first region (10a) of a container (10) to be compressed, with a second holding device (4) that is suitable for holding a second region (10b) of the container (10) to be compressed, wherein the second region (10b) is spaced apart from the first region (10a), with a moving device (20) that is suitable for moving the first holding device (2) towards the second holding device (4) in an infeed direction (Y), in order to compress the container (10) located between the first holding device (2) and the second holding device (4). According to the invention, the apparatus has a transport device (12) in order to transport the container (10) in a specified transport direction (X) that differs from the feeding direction (Y), wherein the transport device is suitable for transporting the container in this transport direction (X) into a position in which the first holding device (2) comes into contact with the first region (10a) of the container.

The present invention relates to an apparatus and a method for compressing containers and in particular plastics material containers. The present invention will be described with reference to plastics material containers, however it is pointed out that the apparatus can also be applied to other containers made from a deformable material. In particular in the professional bar sector it has been known from the prior art for a long time to provide containers with a large volume, for example so-called kegs with a filling capacity of 20 or more litres, which are emptied into tap systems. The handling of such containers is in this respect oftentimes relatively difficult because the relatively heavy kegs also have a relatively large volume and often have to be transported over long distances. Based on these problems, the applicant of the present patent application has adopted a different approach.

The applicant has proposed in an as yet unpublished application to initially produce plastics material containers, to compress them subsequently and stack them inside of each other, to expand them in a further operation, for example at a filling machine, whilst filling them at the same time. However, to date there has been no satisfactory solution for such a compressing of containers.

The present invention is therefore based on the object of providing an apparatus and a method which allow on the one hand a controlled compressing of these containers and which also allow on the other hand an automatic manufacturing of such compressed containers.

According to the invention, these objects are achieved by means of the subject matter of the independent claims. Advantageous embodiments and further developments form the subject matter of the dependent claims.

An apparatus according to the invention for compressing containers and in particular plastics material containers has a first holding device that is suitable for holding and/or receiving a first region of a container to be compressed, as well as a second holding device that is suitable for holding and/or receiving a second region of the container to be compressed, wherein the first region is spaced apart from the second region. In particular, the first region and the second region of the container are here spaced apart from each other in a longitudinal direction of the container. In particular, the first region is a mouth region of the container and the second region is a bottom region.

Further, the apparatus has a movement device that is suitable for moving the first holding device in the direction of the second holding device in an infeed direction, in order to compress the container located between the first holding device and the second holding device.

According to the invention, the apparatus has a transport device for transporting the container in a specified transport direction that is different from the infeed direction, which transport device is suitable for transporting the container in this transport direction to a position in which the first holding device comes into contact or can come into contact with the first region of the container. Advantageously, the holding device is suitable for conveying or transporting the container underneath the first holding device.

According to the invention, it is therefore proposed to feed these containers to the actual compression device that compresses the containers by means of a transport device. In this way, an automated production of such compressed containers can be achieved. Within the internal prior art of the applicant, the above-described compression device is usually at best used for emptying containers, however not for producing compressed containers. This is based on a new approach of the applicant.

Advantageously, a finished container is therefore fed to the apparatus so as to be compressed in particular in an unfilled condition. Advantageously, the movement direction or transport direction and the infeed direction mentioned above are perpendicular to each other. Preferably, the transport direction extends horizontally and the infeed direction extends vertically. It is thus for example possible to convey the containers to be compressed underneath the first holding device and to subsequently lower it down onto the container in order to compress the latter.

Advantageously, the apparatus also includes means for producing the plastics material containers, such as in particular a blow moulding machine, which is particularly preferably installed upstream of the transport device and also upstream of the actual compression device. Therefore, it is proposed in this concept to produce initially the containers, which may in particular be large PET containers, to convey the latter subsequently for the compression thereof and to compress them there. Subsequently, the compressed containers thus produced can be palletised and can be transported for example to a filling machine. Preferably, the blow moulding machine is a stretch blow moulding machine.

In a further advantageous embodiment, the compression device includes a pressure application device that is suitable for applying an internal pressure onto the containers during the compression thereof, which pressure is greater than the ambient pressure. The applicant has discovered that such an application of pressure has an advantageous effect on the compression operation, because the container can thus be compressed along a circumferential fold line.

In a further advantageous embodiment, the apparatus has a carrier, on which several first holding devices are provided for receiving the first regions of the containers. In this way it would for example be possible to arrange, in particular in the transport direction of the containers, several such holding devices one after the other on said carrier or stamp. In this case, a predetermined number of containers can be fed to this multiplicity of holding devices and can be compressed substantially at the same time. Advantageously, at least two, preferably at least three and particularly preferably at least four such holding devices are provided on a common carrier. The receiving of the containers is here not necessarily understood to mean that the containers are received within the holding devices, it is sufficient for the containers to come into contact with the holding devices. Preferably, however, the holding devices have receiving elements for receiving at least a section of the containers, in particular a mouth section of the containers.

In a further advantageous embodiment, the apparatus has positioning means that position at least one container and preferably several containers relative to each other during the transport thereof. In particular, the containers are here arranged relative to each other in such a way that each container can be received or gripped by the holding device associated with this container and can thus be compressed.

In a further advantageous embodiment, the transport device transports the containers in a clocked manner at least at times. This is to be understood in such a way that the containers are not continuously conveyed but at least at times dwell in a position along the transport direction. This is here in particular that position in which also the holding devices are lowered onto the containers in order to compress the latter. However, it would also be possible for the holding device to move, again at times, in the transport direction along with the containers. However, this is technically more complex.

In a further advantageous embodiment, the holding device moves along with the containers in the transport direction. Thus, it would for example be possible for one and preferably several second holding devices to be provided on a carrier of the transport device, such as for example a transport belt or a carrier wheel or preferably a circumferential rail. In this context, the containers could already be placed in the second holding devices and could subsequently be conveyed with the second holding devices to the first holding devices.

Advantageously, therefore, a multiplicity of second holding devices is provided on the transport unit. In a preferred embodiment, these holding devices can move independently from each other. In particular, it is also possible here for a separation between individual second holding devices along the transport path of the second holding devices to be changed. Thus, it would for example be possible for the individual holding devices to each have a magnetic drive, so that in this way the movements of the individual holding devices can be controlled independently from each other. Preferably, a drive of the type of a linear motor is provided for moving the holding device.

In a further advantageous embodiment, the apparatus has an inspection unit for inspecting the compressed container, which inspection unit is provided downstream of the first holding devices in the transport direction of the containers. In this context, this inspection unit can in particular check whether a folding edge of the compressed container is formed in a cleanly curved manner or whether stress whitening or other faults have occurred at individual points of the compressed container. Advantageously, this is here an optical inspection unit that checks the condition of the compressed containers in a contactless manner. Advantageously, the inspection unit has an image acquisition unit such as for example a camera.

In a further advantageous embodiment, the apparatus further comprises a closing or covering unit that attaches a closure element or a cover element to the mouth of the compressed containers. This cover element may for example serve as dust protection.

Further, the apparatus preferably has a removal unit for removing the containers from the second holding devices. In a further preferred embodiment, also ejection or release means are provided which release the compressed containers from the first holding devices. Once the containers have been compressed, they may adhere to the first holding devices. It is therefore preferably proposed to provide release means that actively separate the containers from the first holding devices. This may for example be achieved by applying pressure onto the mouth region of the containers.

However, as an alternative or in addition it would also be possible to release the container by means of pressurised air. Thus, pressurised air may also be applied between the stamp or the first holding device and the container, in order to release the container. The pressurised air is preferably supplied outside of the centring/sealing bell, so that the container is not reinflated by the pressurised air. This means that the pressurised air does not get into the container.

Advantageously, the transport means transport(s) the second holding devices along a circumferential transport path. Thus, a carrier may for example be provided, on which these holding devices are disposed. This may be a movable carrier, such as for example a transport wheel or a so-called transfer star wheel. However, it would also be possible and preferred for the carrier to be a stationary carrier, such as a rail, on which the second holding devices can move. For moving the holding devices, electric motors may be provided on this rail, so that altogether a linear motor drive is achieved.

In a further advantageous embodiment, the second holding device is formed in multiple parts. Advantageously, the first holding device is a holding device that holds a mouth or shoulder region of the container and the second holding device is a holding device that holds the bottom region of the container to be compressed. Thus, the container is preferably compressed along the longitudinal direction thereof. In doing so, a mouth region is preferably inserted into a bottom region of the container. If, as mentioned above, the second holding device is formed in multiple parts it is possible for the containers to be conveyed to the first holding device and for the second holding device to be fed laterally towards the containers, in order to receive the respective bottom regions.

Advantageously, the parts of the second holding device are then fed in a direction towards the containers, which corresponds neither with the transport direction nor with the infeed direction. Advantageously, the direction in which the parts of the second holding device are fed towards the containers is perpendicular to the transport direction and/or perpendicular to the infeed direction of the first holding device.

The present invention is further directed to a method for compressing containers. In this respect, plastics material containers are initially provided and subsequently these plastics material containers are compressed, wherein a first holding device holds a first region of the container to be compressed, a second holding device holds a second region of the container to be compressed, wherein the second region is spaced apart from the first region, and a movement device moves the first holding device towards the second holding device in an infeed direction, in order to compress the container located between the first holding device and the second holding device.

According to the invention, the container is transported to the first holding device in a specified transport direction using a transport device. Preferably, the container is transported to a region directly underneath the first holding device, so that this first holding device can be fed towards the container. Advantageously, the containers are transported empty and preferably the containers are also compressed empty. In a further advantageous method, the transport direction of the empty containers and the infeed direction of the first holding device are different from each other.

Advantageously, the containers are produced immediately prior to the compression thereof, for example by means of a blow moulding machine. However, it would also be conceivable for the containers to be used multiple times. Preferably, in a non-compressed condition, the containers have a filling capacity that is greater than 5 l, preferably greater than 10 l, preferably greater than 20 l. Preferably, the containers have a circular cross section.

Advantageously, the containers are clocked, transported and the transport is in particular stopped, as soon as the containers are located underneath the first holding devices.

In a further advantageous method, the containers are conveyed at least in sections along a linear path. However, it would also be possible for the containers to be conveyed along a rotatable carrier and for several holding devices to be arranged along a segment of a circle one behind the other. Preferably, the containers are transported at least in that section that is located directly in front of the first holding devices, along a linear path, and particularly preferably also in that section that immediately follows the first holding devices.

In a preferred method it is possible for one and preferably several holding device(s) to be located in a top position, in which they may be located above the containers. Preferably, this position of the holding devices is scanned or checked. Further, one stop element each may preferably be provided on each of the holding devices, which stop element contacts, during the compression operation, a circumferential fold that is formed during the compression process, and thus facilitates the compression operation.

Advantageously, at least two, preferably at least three containers are compressed substantially at the same time. Advantageously, the containers are compressed in an upright position.

Further advantages and embodiments will result from the attached drawings, wherein:

FIG. 1 shows a schematic view for illustrating a method according to the invention;

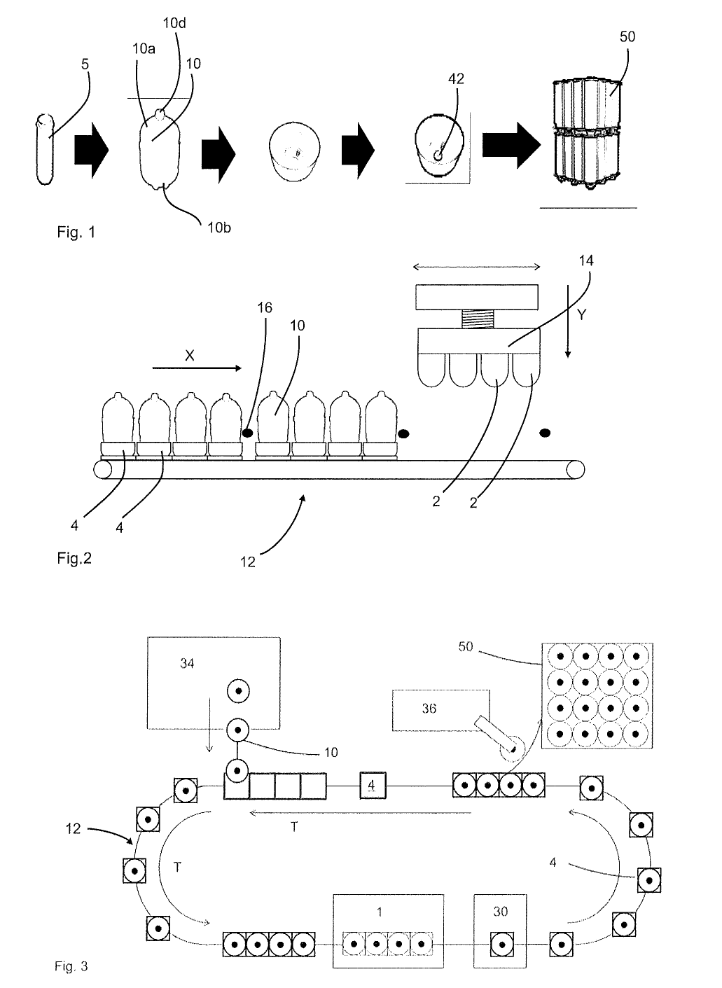

FIG. 2 shows an apparatus for compressing containers in a first embodiment;

FIG. 3 shows a top view of an apparatus according to the invention;

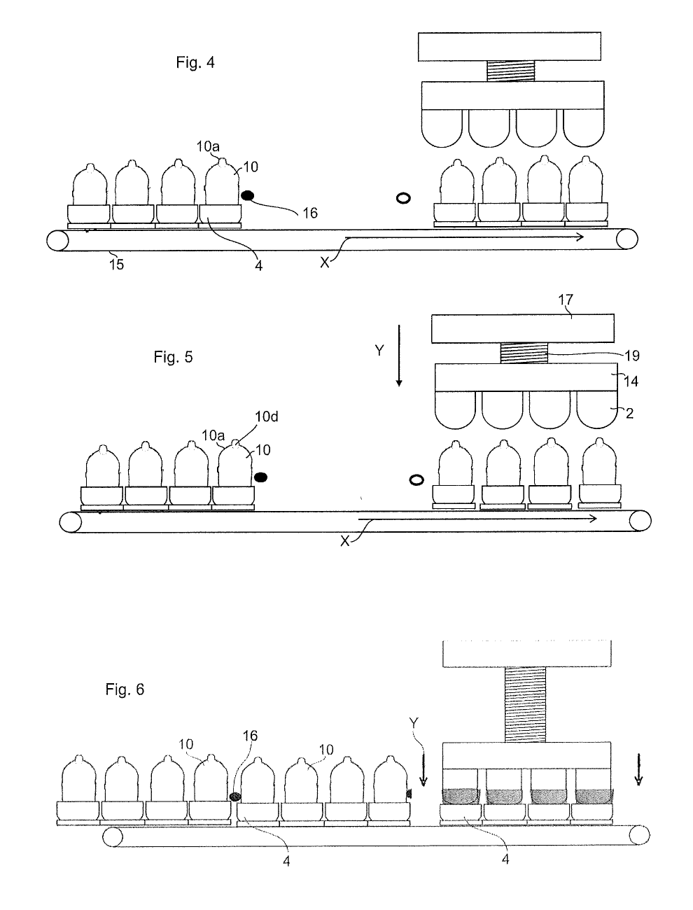

FIG. 4 shows a view of the apparatus according to the invention in a further stage of the process;

FIG. 5 shows a view of the apparatus according to the invention in a further stage of the process;

FIG. 6 shows a view of the apparatus according to the invention in a further stage of the process;

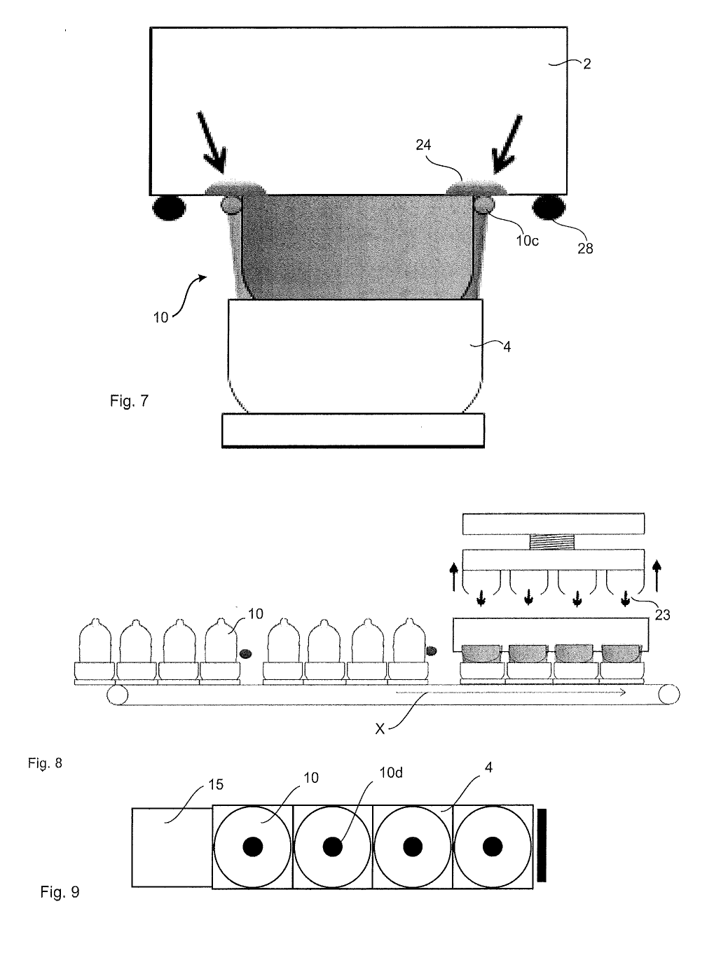

FIG. 7 shows a detailed view for illustrating a compression operation of a container;

FIG. 8 shows a further view of the apparatus according to the invention in a further stage of the process;

FIG. 9 shows a view of holding devices with containers;

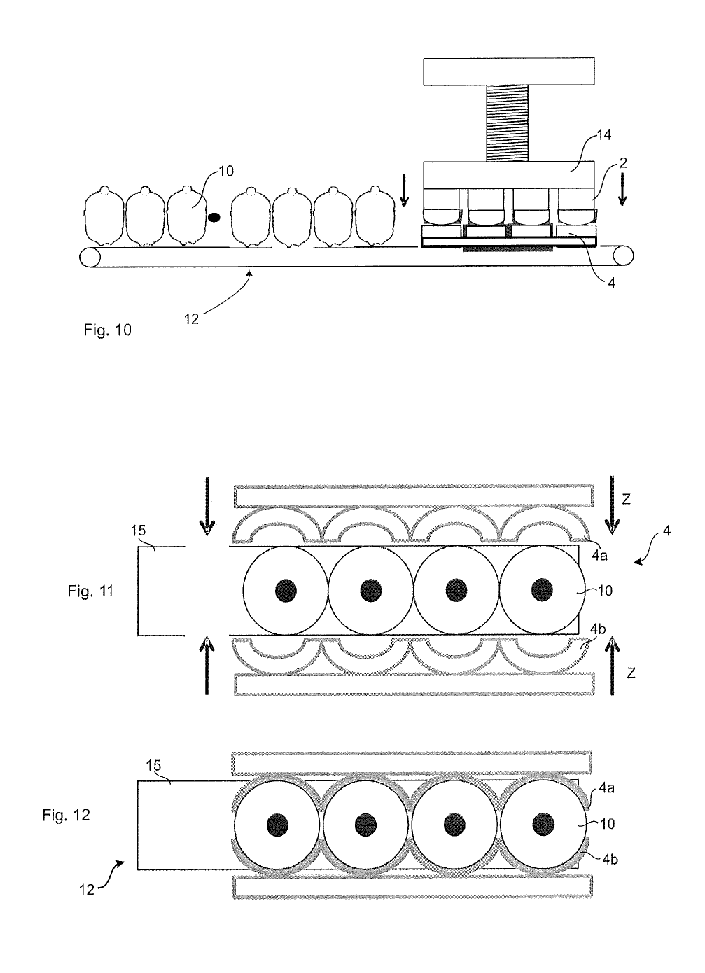

FIG. 10 shows a further view of a method according to the invention;

FIG. 11 shows a view of an apparatus according to the invention with a further advantageous arrangement of the second holding devices;

FIG. 12 shows the view of FIG. 11 with closed holding devices;

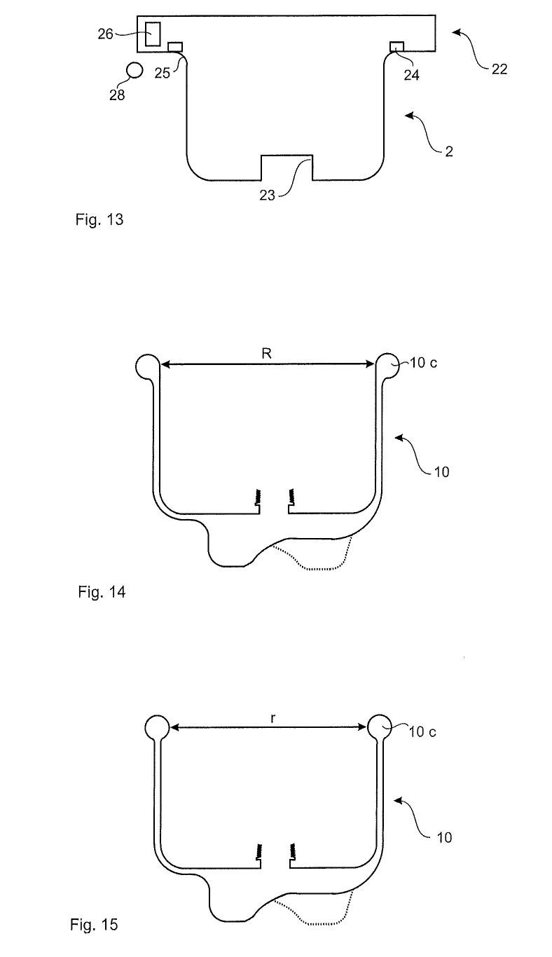

FIG. 13 shows a further view for illustrating the compressing of a container;

FIG. 14 shows a further view for illustrating the compressing of a container;

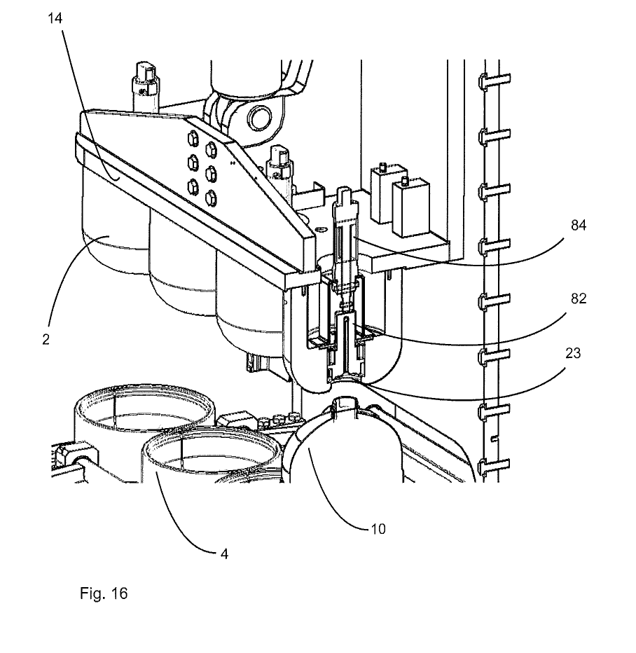

FIG. 15 shows a further view for illustrating the compressing of a container; and

FIG. 16 shows a view of an apparatus according to the invention.

FIG. 1 shows an illustration of the method for producing the compressed containers. As the basis, a plastics material preform 5 is initially assumed here, which is transformed into the container 10 by means of a shaping unit such as for example a stretch blow moulding machine. In a further process step, this transformed container is compressed using in particular the apparatus according to the invention in such a way that a mouth region of the plastics material container is inserted into a bottom region of the plastics material container. Reference numeral 10a identifies a first region of the container to be compressed, which is a region that also contains the mouth of the container. Reference numeral 10b identifies a second region of the container to be compressed, which may here be a bottom region.

In a further process step, a cap or closure 42 is placed on the mouth. Subsequently, a multiplicity of such compressed containers is compiled into a pallet 50.

FIG. 2 shows an illustration of an apparatus according to the invention for compressing the containers. Here, four first holding devices 2 are provided, which interact with the mouth region of the containers for compressing the containers and push or compress the latter in the direction of the second holding devices 4.

In the embodiment shown here, four such first holding devices 2 are provided on a common carrier 14 and can thus be fed to the containers 10 downwards in the infeed direction Y.

Reference numeral 12 identifies a transport unit in its entirety, which is here used for transporting the containers. More specifically, this transport unit feeds the uncompressed containers to the first holding devices 2 and subsequently preferably also conveys the compressed containers away from the compression device. Reference numeral 16 relates to a position sensing unit such as a light barrier, by means of which the position of the containers along their transport direction X can be determined. It would also be conceivable here for the transport device itself to be controlled as a function of a signal of this position sensing unit. However, it would also be possible for the movements of the individual second holding devices 4 to be controllable independently from each other, and these controls could preferably also be carried out as a function of the position sensing unit.

Apart from that, also blocking elements may be provided which, at least temporarily, prevent any further transport of the second holding devices 4 along the transport direction x.

In the starting situation shown in FIG. 2 (the following description also relates to the further figures), all of the first holding devices 2 or all of the stamps are located in a top position, During this process, the holding devices are advantageously scanned to check whether they are actually in a top position. Further, at this point in time, preferably a stop (not shown) is preheated on the holding devices, in particular to a temperature in a range between 50° C. and 80° C., preferably between 55° C. and 75° C., preferably between 60° C. and 65° C. In doing so, this temperature is preferably scanned and controlled by means of a controller. The purpose of this tempering will be explained in more detail below.

In the embodiment shown in FIG. 2, four containers are standing in a single carrier on a transport belt. On the controller side, a scan may again be carried out to check whether actually all of the here four containers are present. As long as this is not yet the case, a container barrier may be closed to prevent that less than a predetermined number of containers, here less than four containers, reach the first holding devices.

FIG. 3 shows a further illustration of an apparatus according to the invention. Here, too, the transport device 12 is provided, which transports here the individual second holding devices 4 along a circumferential transport path T. This transport path contains here straight sections and curved sections. However, the transport path preferably extends in one plane. As shown in the figure, the plastics material containers 10 are initially produced in a transforming device 34 and are subsequently placed in the respective second holding devices 4.

Subsequently, the individual holding devices 4 are grouped into groups of four and arrive at the apparatus 1 according to the invention, in which the plastics material containers are compressed. In the case of the embodiment shown in FIG. 3, the movement of each individual holding device 4 is independent from the movements of further holding devices 4. In this way, different groups may be selectively compiled, but the groups of holding devices may also be dissolved again.

In the transport direction of the containers downstream in relation to the apparatus 1, there is an inspection unit 30 that inspects the individual plastics material containers produced. In the course of this, an individualisation of the individual holding devices 4 may already be carried out in this region. Subsequently, the holding devices 4 with the compressed containers 10 contained therein are fed to a palletising unit 36 that forms pallets 50 of compressed plastics material containers. A capping unit (not shown) may also be located between the apparatus 1 and the palletising unit, which places caps on the mouths of the compressed containers 10.

In the method shown here and in the introduction above, four containers are moved in a carrier here at a maximum speed underneath the first holding devices. The separation is here specified in particular by the size of the individual carriers or of the second holding devices 4. The holding devices 4 may in turn be fixed (or disposed to be movable) to the transport unit 12 via carrier elements. In a further step a scan is carried out to check whether the four containers are actually present.

The transport unit may further include acceleration and deceleration regions, which accelerate or decelerate the transport movement of the individual holding devices. Alternatively, however, the transport unit may also be a transport belt on which the individual holding devices are disposed. It would also be conceivable to use transport chains or rotatable transport units.

The four stamps or the first holding devices 2 continue to move to a point just before the mouth of the individual containers. It is again possible to carry out a scan of the position and of the speed of the individual first holding devices. Advantageously, the first holding devices are fed to the plastics material containers at a speed between 100 mm/s and 500 mm/s, preferably between 200 mm/s and 400 mm/s and particularly preferably of approx. 300 mm/s.

The individual stamps or holding devices 2 are now slowly moved downwards and thus compress the containers. In the course of this, the containers are preferably initially centred. Advantageously, the individual holding devices each have centring elements such as so-called centring bells. Advantageously, the individual first holding devices also include sealing units or elements, which limit the flow of air through the mouths during the compressing.

Advantageously, again, a position of the first holding device 2 in the infeed direction Y is scanned using a sensing device.

Further, the containers are pre-tensioned using a specified pressure, for example 0.5 bar above atmospheric pressure. Advantageously, also pressure gauging devices are provided which determine the internal pressure in the containers during the compression operation. Also control units for controlling the internal pressure in the container may be provided.

The holding devices now accelerate downwards and in this way the containers are rolled inwards. In the course of this, an internal pressure builds up in the containers. In the course of this, certain parameters, such as a position of the holding devices, a press-on force and the speed, may again be checked. Advantageously, a compressive force is in a range of 50 kN to 100 kN, preferably between 60 kN and 80 kN and preferably approx. 70 kN (calculated here for four holding devices). The speed at which the plastics material containers are fed or compressed is preferably between 50 mm/s and 200 mm/s, preferably between 70 mm/s and 130 mm/s.

Advantageously, a valve unit is further provided, which opens once a certain positive pressure inside the container has been reached, so that the maximum pressure inside of the container is not exceeded. Advantageously, this maximum pressure is between 2 bar and 3 bar and is preferably 2.5 bar. Preferably, the internal pressure in the container is mechanically and/or electrically controlled. To this end, for example a defined nozzle or aperture, but also a pressure control valve may be provided.

During the compression operation, a circumferential roll-in fold of the container is preferably formed. This presses, preferably at the lowest position of the first holding device, against a radius of the first holding device and in the course of this preferably rolls outwards by a few millimetres. Preferably, again, the end position of the holding devices is scanned, which may for example be carried out using a limit switch or by way of sensing a position of the holding devices.

Preferably, the first holding devices are briefly held in this position, in order, as will be described in more detail below, to temper the roll-in fold at said groove.

In a further process step, the holding devices move back upwards, preferably at a higher speed. It is conceivable here for the centring bell or a further element to push the rolled-in container downwards. The speed of this return movement is here advantageously again between 200 mm/s and 400 mm/s and is advantageously approx. 300 mm/s.

The containers, which are now compressed or rolled in, stay in the second holding device or in the bottom cup. In these holding devices, the containers thus rolled in are transported off and at the same time four further containers may be transported to the first holding devices 2. Here, too, a scan may be carried out again to check whether the four already compressed containers have been moved out. To this end, for example a double light barrier may be provided.

The rolled-in containers are removed from their holding devices, are preferably provided with a dust cap and are palletised. The empty second holding devices move again to the blow moulding machine in order to receive the next containers.

FIG. 4 shows a further illustration of an apparatus according to the invention. Here, the four containers 10 move at a maximum speed underneath the stamp or the first holding devices. To this end, the transport belt 15 may again include an acceleration or deceleration ramp. However, it can be seen that in FIG. 4 the position of the individual containers has not yet been exactly orientated. To this end, an exact positioning may be carried out for example by way of a corresponding movement of the transport device, but also by way of an individual movement of the individual holding devices 4. However, the second holding devices may also be constructed or designed in such a way that, due to their size, they already have the correct separation of the containers underneath the press or underneath the first holding devices.

In the situation shown in FIG. 5, the containers 10 or the mouth regions 10a thereof are orientated with the mouths 10d exactly underneath the holding devices. Reference numeral 17 schematically identifies a drive unit that effects the infeed movement of the first holding devices 2. This drive unit 17 may for example include one or several drive spindles 19. Apart from that, however, it would also be possible to use a linear-motoric or a pneumatic or a hydraulic drive as the drive. Particularly preferably, a hydraulic drive is used which in particular is characterised by its small installation size and its maintenance possibilities.

In the situation shown in FIG. 6, the first holding devices 2 are now fed to the second holding devices 4, and in this way, the plastics material containers located therebetween are compressed. It can be seen that here already two further groups of containers may be ready to be subsequently compressed.

FIG. 7 shows a detailed view of a roll-in process. Here, the first holding device 2 is shown again, which is fed to the second holding device 4. In this respect, the first holding device has a circumferential groove 24 that contacts a roll-in fold 10c during the compression of the container. As a result of this contact with the roll-in fold 10c, the roll-in process may be altogether improved, and in particular the formation of stress whitening in the container may be prevented. As mentioned above, this circumferential stop is advantageously tempered. Apart from that, the first holding device also preferably has an extension, i.e. a section in which a cross section of the holding device expands from the bottom towards the top. This section (not shown in FIG. 7) is also used for acting on the roll-in fold 10c. In addition to that, position sensing means 28 may be provided, which sense a position of the roll-in fold 10c and/or a relative position between the holding devices 2, 4.

It would further be possible to utilise and thus to recycle the pressurised air pressed out of the container during the compression operation, again for pre-tensioning the subsequent containers. It would also be conceivable to utilise waste air from the upstream blow moulding machine, in order to apply a pressure onto the containers. The advantage could be that for example cleaned air or sterile air from the blow moulding machine may also be used for pre-tensioning. Also, the generated pressurised air may be used for pneumatic drives.

FIG. 8 shows a further illustration of the apparatus according to the invention, wherein here also centring elements 23 are indicated which centre the plastics material containers 10 when they are fed towards the latter. These may for example be so-called centring bells which orientate a mouth section of the containers.

FIG. 9 correspondingly shows an arrangement of four second holding devices 4 with plastics material containers 10 disposed therein. Reference numeral 15 identifies a transport means such as a transport belt or a transport carrier. Reference numeral 10d relates to a mouth section of the containers 10.

In the illustration shown in FIG. 10, as mentioned above, the holding devices 2 are fed towards the holding devices 4 and the containers are thus completely compressed. In the course of this it is advantageous if during the compression operation, no sharp-edged folds with so-called stress whitening occur, because the containers would otherwise have unsightly folds and weak points would develop on these folds, so that the containers no longer have the required pressure stability and may thus be unusable for example for carbonated drinks. However, in order to ensure that the containers are well compressed and are not just crumpled up, it is proposed here that the containers are pre-tensioned with a slight pressure, for example using a valve in the stamp, which is sealed on top of the mouth. Subsequently, the holding device 2 presses the container together and as a result of the volume reduction, the pressure in the container continues to rise. In this context it is pointed out that the internal pressure in the container may not rise in an uncontrolled manner, because otherwise the pressure force would rise to an extreme to such an extent that the container could finally burst. Therefore, the air is released out of the container in a controlled manner once a certain pressure has been reached, in order to maintain a certain pressure level in the container. As mentioned above, the applicant has found that the roll-in process can be carried out at a pressure in the region of 2 to 2.9 bar and preferably of approx. 2.2 bar (positive pressure) or more in such a way that an aesthetic roll-in fold can be achieved.

For pressure control, an electronic pressure control valve may be used that opens, once a specified pressure has been reached in the container, to such a degree that the pressure will by no means rise any further. This in turn is advantageous because the necessary force for compressing the containers directly depends from the pressure in the container. At an internal pressure of 2.5 bar, the force on the holding devices, or on each individual holding device, already is approx. 15.3 kN, which corresponds to a weight force of approx. 1.53 t. On the other hand, if the pressure is too low, uncontrolled folds with stress whitening could form on the container.

It would further also be conceivable to release the pressure from the container for example via a mechanical throttle such as a perforated sheet. In this case, however, a substantially constant volume flow would be required. For example, a stagnation pressure in the order of 2.5 bar would build up at a volume flow of 4 l/s through an aperture of 4.6 mm in diameter, which would lead to the same result.

The advantages of the invention consist in the fact that in this way, the compressed containers can be easily stacked up, they can also be transported in a cost-effective manner and at the same time maintain their properties. After having been rolled out, the containers still have the same barrier properties and the same pressure stability as before the rolling in, provided no sharp-edged folds in stress whitening develop in the PET material.

FIGS. 10 to 12 show a further embodiment of the apparatus according to the invention. Here, too, the containers 10 are fed to the first holding devices 2 via a transport device 12. However, whilst in the previous embodiments the containers were already located in the second holding devices 4, these second holding devices are now located stationary underneath the first transport devices 2 in or in respect of the transport direction of the containers. In this case, the containers are also moved into the intended position for compression and subsequently the second holding devices 4 are closed.

FIG. 11 illustrates this process. It can be seen that the second holding devices 4 are designed in two parts and have a part 4a and a part 4b. As soon as the containers 10 are in the correct position, these parts 4a, 4b are fed towards each other in the direction Z, so that the condition shown in FIG. 12 results. Subsequently, the containers are compressed using the first holding devices 2 (not shown) which come from the top in FIGS. 11 and 12.

This embodiment has an advantage in that the second holding devices 4 will always be correctly positioned in relation to the first holding devices 2 in the transport direction X of the containers 10. However, the second holding devices here have to be formed in two parts and preferably in the form of half shells.

FIG. 13 illustrates the compression of the container and in particular the effect on the roll-in fold 10c. This roll-in fold 10c is shown in FIG. 14. It can be seen that the first holding device 2 has a circumferential projection 22. This circumferential projection or radius presses, during the compression of the container 10, against the roll-in fold 10c and rolls this outwards by a few millimetres. Reference numeral 25 identifies a transitional region of the first holding device 2. In this transitional region 25, a cross section of the first holding device 2 expands from the bottom to the top. This is preferably a steady expansion. Preferably, the holding device has a circular cross section (perpendicular to the feeding direction) at least in the transitional section. It can also be seen here that this transitional region is formed to be curved. Reference numeral 24 identifies a heating unit that heats the stop or also the transitional region 25. Reference numeral 26 identifies in a roughly schematic manner a pressure application unit that can promote the release of the container from the first holding device by applying pressurised air to it.

Position scanning means 28 can again be used to scan the end position, and advantageously also the position of the roll-in fold 10c can be checked. Reference numeral 23 identifies a centring section that is used for centring the container and can receive the mouth region of the container or a thread of the container.

FIG. 14 shows a view of a rolled-in container. Tempering was used here, which means the transitional region 25 was heated by means of the heating unit 24. It can be seen that the roll-in fold 10c is here pressed outwards, so that the radius R results. In this way it is possible to stack the compressed containers inside of each other and to separate them again from each other.

FIG. 15 shows a view in which no tempering was used. It can be seen that here the radius r is smaller than the radius R shown in FIG. 14 or that the roll-in fold 10c protrudes further inwards. These roll-in folds surround the next container tightly during stacking and are harder to separate again afterwards.

Finally, FIG. 16 shows a view of an apparatus according to the invention. Here again the second holding devices 4 are shown, but it is here not essential whether these are moved together with the transport unit or whether they are already located underneath the first holding devices 2. Further, one of the first holding devices 2 with the interior thereof is shown. A ram element 82 can be seen here which can be moved in the vertical direction, i.e. in the direction Y, in which also the first holding devices 2 are fed towards the containers 10. In order to separate the containers 10 from the first holding devices 2, this ram element 82 can be pushed downwards, so that they push the compressed container away. Reference numeral 84 identifies a drive unit such as for example a hydraulic and preferably pneumatic drive unit, which initiates the movement of this ram element 82.

However, this ram element 82 can also be used during the compression process in order to partially seal the mouth 10a of the container, so that only a predefined amount of air can escape from the container during the compression process. However, it would also be possible to use different elements on the one hand for pushing away the containers and on the other hand for the sealing thereof.

The applicant reserves the right to claim all of the features disclosed in the application documents as being essential to the invention, in as far as they are novel over the prior art either individually or in combination.

### LIST OF REFERENCE NUMERALS

1 Apparatus

2 First holding devices

4 Second holding devices

4a, 4b Parts

5 Plastics material preform

10 Containers

10a Mouth regions

10b Bottom regions

10c Roll-in fold

10d Mouths

12 Transport unit

14 Carrier

15 Transport belt

16 Position determining unit

17 Drive unit

19 Drive spindle

22 Projection

23 Centring section

24 Heating unit

25 Transitional region

26 Pressure application unit

28 Position scanning unit

30 Inspection unit

34 Transformation unit

36 Palletising unit

42 Closure, cap

50 Pallet

82 Ram element

84 Drive unit

Y Infeed direction

X Transport direction

T Transport path

Z Direction

R Radius

r Radius Patent Claims

1. An apparatus (1) for compressing containers (10) and in particular plastics material containers using a first holding device (10) that is suitable for holding a first region (10a) of a container (10) to be compressed, with a second holding device (4) that is suitable for holding a second region (10b) of the container (10) to be compressed, wherein the second region (10b) is spaced apart from the first region (10a), with a movement device (20) that is suitable for moving the first holding device (2) towards the second holding device (4) in an infeed direction (Y), in order to compress the container (10) located between the first holding device (2) and the second holding device (4), characterised in that
the apparatus includes a transport device (12) in order to transport the container (10) in a specified transport direction (X) that is different from the infeed direction (Y), wherein the transport device is suitable for transporting the container in this transport direction (X) into a position in which the first holding device (2) comes into contact with the first region (10a) of the container.

2. The apparatus (1) as claimed in claim 1, characterised in that
the apparatus (1) has a carrier (14), on which several first holding devices (2) are disposed for receiving the first region of several containers (10).

3. The apparatus (1) as claimed in at least one of the preceding claims,
characterised in that
the apparatus (1) includes positioning means (16) that position several containers (10) during the transport thereof by means of the transport device (12) relative to each other.

4. The apparatus (1) as claimed in at least one of the preceding claims,
characterised in that
the transport device (12) transports the containers (10), at least at times, in a clocked manner.

5. The apparatus (1) as claimed in at least one of the preceding claims,
characterised in that
the second holding device (4) moves together with the containers (10) in the transport direction (X).

6. The apparatus (1) as claimed in at least one of the preceding claims,
characterised in that
a multiplicity of second holding devices (4) is provided on the transport device (12).

7. The apparatus (1) as claimed in at least one of the preceding claims,
characterised in that
the apparatus (1) has an inspection unit (30) for inspecting the compressed containers (10), which inspection unit is disposed downstream, in a transport direction of the containers (10), in relation to the first holding devices (2).

8. The apparatus (1) as claimed in at least one of the preceding claims,
characterised in that
the second holding device (4) is formed in multiple parts.

9. A method for compressing containers (10), comprising the following steps:
providing plastics material containers (10);
compressing said plastics material containers (10), wherein a first holding device (2) holds a first region (10a) of a container (10) to be compressed, a second holding device (4) holds a second region (10b) of the container (10) to be compressed, wherein the second region (10b) is spaced apart from the first region (10a) and a movement device moves the first holding device (2) towards the second holding device (4) in an infeed direction (Y), in order to press the container (10) located between the first holding device (2) and the second holding device (4);
characterised in that
the container is transported towards the first holding device in a specified transport direction using a transport device (12).

10. The method as claimed in claim 9, characterised in that
several containers (10) are compressed substantially at the same time.
